(19) United States
(12) Patent Application Publication
(10) Pub. No.: US 2024/0383727 A1
(43) Pub. Date: Nov. 21, 2024

(54) INTERNAL LINE ROUTING FOR WORKING MACHINES HAVING BOOM ARMS

(71) Applicant: KOMATSU FOREST AB, Umeå (SE)

(72) Inventors: Brett JONES, Drummoyne (AU); Timothy REEN, Concord (AU)

(21) Appl. No.: 18/691,581

(22) PCT Filed: Sep. 14, 2022
(86) PCT No.: PCT/EP2022/075486

§ 371 Date: Mar. 13, 2024

(30) Foreign Application Priority Data
Sep. 15, 2021 (AU) 2021232719

(51) Int. Cl. B66C 3/00; A01G 23/00; B66C 1/42; B66C 1/58

(52) U.S. Cl. CPC B66C 3/005; B66C 1/427; A01G 23/003; B66C 1/585

(57) ABSTRACT

A system (100) comprising a boom tip attachment bracket (108) on a boom (102) of a working machine, the boom (102) having an actuator (104) attached thereto and one or more flexible lines (106), a processing head attachment bracket (110) for rigidly attaching a processing head (112) to the boom (102) of the working machine, the processing head attachment bracket (110) having a line connection point (114) for connecting the one or more flexible lines (106), and an internal line passage (116) for passage of the one or more flexible lines (106) from the boom (102) to the line connection point (114). The boom tip attachment bracket comprises (108) a first rigid frame (118) having at least two plates (120a, 120b) spaced from each other by a first spacing distance (122) so as to comprise at least a portion of the internal line passage (116), and a pair of first coupling points (124a, 124b) opposed across the first spacing distance (122), for rotatably coupling the rigid frame (118) to the processing head (112) along a first rotation axis (126a). The processing head attachment bracket comprises a second rigid frame (128) having at least two plates (130a, 130b) spaced from each other by a second spacing distance (132) so as to comprise at least a portion of the internal line passage (116); and a pair of second coupling points (134a, 134b), opposed across the second spacing distance (132), and rotatably coupled with the pair of first coupling points (124a, 124b) along the first rotation axis (126a). The processing head attachment bracket (110) is coupled to the actuator (104) by a torque assembly (136) for translating actuation of the actuator (104) into a rotation of the processing head attachment bracket (110) about the first rotation axis (126a), and the internal line passage (116) passes through at least the first rotation axis (126a).

### TECHNICAL FIELD

The present invention relates to working machines, such as forestry machines having boom arms. In particular, the present invention relates to an internal line routing for a working machine having a processing head attachment rigidly attached to a boom.

### BACKGROUND

Working machines such as forestry machines or excavators may comprise one or more articulated boom arms with processing heads attached thereto for performing processing (e.g. industrial or agricultural processing). The booms and processing heads are typically moved and controlled through actuation of one or more actuators attached to the boom, for example hydraulic actuators, pneumatic actuators, and the like.

Processing heads require a supply of power and, in some cases, data (e.g., for more complex processing heads that may be required to read sensor data or control function on the processing head). The power may be supplied in the form of electrical or hydraulic power. This power and/or data will typically be supplied from pumps, computers, or batteries located in the main body of the working machine, and be taken up the articulated boom to the processing head by a series of supply lines (also referred to as ‘lines’) such as hoses, pipes, cables (electrical, data, and the like), etc.

For example, a harvester forestry machine comprises a harvester head at the end of an articulated boom, the harvester head typically having a clamping arrangement for securing to a tree to be felled, as well as a saw for felling the tree. Harvester heads may also comprise feed rollers for feeding the felled tree through a set of knives, thus removing excess branches from the felled tree. The clamping arrangement and the articulation of the head itself may be powered hydraulically, the saw and feed rollers may be powered electrically, and the feed rollers may also provide data in respect of physical dimensions, such as length and diameter, of the felled tree that has been processed.

Processing heads that are rigidly attached to the boom, meaning that the head is rigidly articulatable about the boom tip (as opposed to, for example, hanging, dangling, etc. from the boom tip) comprise mechanical assemblies arranged on the boom for articulating the processing head relative to the boom. However, during articulation of processing heads, there is a risk that the lines/hoses may be caught in the mechanical assemblies and become damaged, or may have trees, limbs, or other debris falling thereupon. Therefore, a typical approach for routing the lines/hoses involves passing flexible lines from the boom to the processing head whilst staying well clear of the attachment therebetween. The lines/hoses are made flexible to allow for motion and articulation of the boom and the processing head.

Given the industrial, agricultural, or forest settings that the aforementioned working machines operate in, there is a tendency for debris to fall onto the working machines during operation. The booms may also collide accidentally with their surroundings during operation. In these cases, there is further risk of damage to the lines/hoses that are running along the boom to the processing heads.

### SUMMARY OF THE INVENTION

The present disclosure provides an improved hose routing from the boom to the processing head of a working machine that overcomes one or more of the aforementioned problems in existing working machines having rigidly attached processing heads.

According to a first aspect, there is provided a system comprising a boom tip attachment bracket on a boom of a working machine, the boom having an actuator attached thereto and one or more flexible lines, a processing head attachment bracket for rigidly attaching a processing head to the boom of the working machine, the processing head attachment bracket having a line connection point for connecting the one or more flexible lines, and an internal line passage for passage of the one or more flexible lines from the boom to the line connection point. The boom tip attachment bracket comprises a first rigid frame having at least two plates spaced from each other by a first spacing distance so as to comprise at least a portion of the internal line passage, and a pair of first coupling points opposed across the first spacing distance, for rotatably coupling the rigid frame to the processing head along a first rotation axis. The processing head attachment bracket comprises a second rigid frame having at least two plates spaced from each other by a second spacing distance so as to comprise at least a portion of the internal line passage; and apair of second second coupling points, opposed across the second spacing distance, and rotatably coupled with the pair of first coupling points along the first rotation axis. The processing head attachment bracket is coupled to the actuator by a torque assembly for translating actuation of the actuator into a rotation of the processing head attachment bracket about the first rotation axis, and the internal line passage passes through at least the first rotation axis.

By routing the flexible lines/hoses through the rigid frame(s) comprising the attachment brackets, the rigid frames can serve as protection for the hoses from debris, collisions, and other potential damage. These lines or hoses may be hydraulic fluid hoses, pneumatic hoses, electrical power cables, data (e.g. CAN) cables, and/or some other flexible line or cable required for routing from the main carrier body of the working machine to the processing head attached to a boom thereof.

When articulating the processing head through its full range of rotational motion around the boom, i.e. extending the actuator from a minimum extension to a maximum extension, the flexible hoses will move through the rigid frames of the attachment brackets. Therefore, by allowing an internal hose passage through the frames that passes through the primary rotation axis (i.e. the rotation axis about which the processing head is rotated during articulation), it can be ensured that the flexible hoses have a clear and unimpeded passage through the attachment brackets.

As a further advantage, the internal hose routing according to the present disclosure allows for a minimal length of flexible hosing to be used, as the hosing can pass directly from the boom to the processing head without needing to account for obstructive mechanical joints such as through-going clevis pins, structural supports, or the like.

A particular comparative example is considered, where the boom tip attachment bracket may be attached to the processing head attachment by means of a solid pin (such as a clevis pin) extending through the length of the rotational coupling. In such a comparative example, if it were attempted to route the hoses internally through the brackets, the routing would need to go outside and around this coupling, above the coupling, or below the coupling.

Disadvantages of going outside of the coupling (e.g. risk of damage to the flexible hoses) have been discussed above. When considering the passage of the flexible hoses above or below the coupling, there are further disadvantages. For example, if the processing head were fully rotated away from the passage of the hose (i.e., all the way down if the hose has been passed above the coupling and vice versa), then the flexible hose may have minimal slack. However, when the processing head is moved to the other extreme, there is a maximal slack in the flexible hose as its length must have been increased in order to account for the obstruction of the throughgoing solid pin. This excess hose length is wasteful from a manufacturing perspective and would need to be accommodated for elsewhere in or around the attachment brackets, thus potentially wasting further space in the attachment brackets.

Thus, according to the first aspect, the first and second pairs of coupling points may take any form that allows for a relative rotation of the brackets whilst providing a space therebetween for passage of the internal hoses. For example, the coupling of the boom tip attachment bracket and the processing head attachment bracket may take the form of a ‘dual clevis’ joint, i.e. two clevis connections along the first rotation axis either side of the internal hose passage. In this example, each of the pair of first coupling points may comprise an aperture configured to receive a clevis pin, and each of the pair of second coupling points may comprise a clevis configured to receive a clevis pin. Then, the pair of first coupling points and the pair of second coupling points may be rotatably coupled by respective clevis pins extending through the clevis and the aperture.

The at least two plates of the first rigid frame are spaced apart to provide for the internal hose passage, and this spacing may be provided in such a way as to maintain structural rigidity of the frame without impeding the passage of the hoses. For example, the first rigid frame may comprise a support plate extending between an edge of each of the at least two plates of the first rigid frame, thus avoiding the more central portion of the first rigid frames where the internal hoses may be passing through and/or moving through during articulation of the processing head.

The flexible hoses may have been fed through a length of the boom before entering the internal hose passage of the boom tip attachment bracket, thus preventing them from being exposed to an external environment which could cause damage to the flexible hoses. Alternatively, the flexible hoses may be guided along an outside of the boom and enter the internal line passage of the boom tip attachment bracket. In this latter case, the support plate may provide an opening to the internal line passage to allow the flexible lines/hoses to be passed from the boom, through the opening, and into the internal line passage for ultimately connecting to the line connection point of the processing head attachment bracket.

If the lines/hoses are guided along an outside of the boom, the boom may comprise a line guide (or ‘hose guide’ or simply ‘guide’) from which a first end of the one or more flexible lines extends, configured to guide the flexible lines along the boom to the internal line passage. The guide may be a series of clamps arranged to fix the lines/hoses to the boom, a channel formed along the boom and enclosed by netting, and/or some other guiding element configured to prevent the lines/hoses from becoming snagged, caught, or otherwise damaged during operation. The guide may then terminate proximate to the opening so as to allow the lines to pass into the internal line passage.

Whilst flexible lines are used within the internal line passage to allow for flexing, bending, twisting (or the like) during articulation of the processing head, the lines may be solid or rigid along the boom, for example in the form of plastic or metal pipes. Further, the guide may comprise a protective conduit fixed to the boom, through which flexible lines/hoses may pass or to which flexible lines/hoses may be sealably attached. For example, the boom may interface with a processing head via a bulkhead comprising one or more line connection points, to which one or more lines are coupled. Thereafter, one or more lines are connected onto the opposing side of the bulkhead so as to form a secure interface between the boom and the processing head, passing into and through the internal line passage.

As examples, the protective conduit may be a hard plastic pipe that is clamped to the boom and a power cable may be passed through the hard plastic pipe so as to protect the power cable from damage, should debris fall onto the boom, for example. Alternatively, the protective conduit may be a steel pipe configured to provide hydraulic fluid and the end of the steel pipe may have a fluid-tight coupling with the one or more flexible hoses. In some examples, a hose (e.g. reinforced with metal) may be used to route lines or other hoses therethrough, thus providing further protection for the lines/hoses.

It will be appreciated that other arrangements are possible, and that multiple hoses may be passed through or be coupled to an end of a same protective conduit. In some examples, the hydraulic fluid may be provided in a same conduit as a power or data cable, provided that the cable is sufficiently isolated from the hydraulic fluid and that the conduit is sufficiently large as to allow the passage of the hydraulic fluid around the cable. This may have a dual advantage of providing a minimal number of conduits and providing potential cooling for, e.g., a power cable which may be carrying high electrical loads.

The guide (comprising a protective conduit or otherwise) may be provided on an underside of the boom. This allows for a further protection of the hoses from debris that may be falling onto the boom. As used herein, ‘underside’ is intended to mean a side that is opposite to a side that would have objects falling under gravity incident thereupon.

The processing head attachment bracket (and, by extension, any processing head attached thereto) is rigidly articulated by the actuator on the boom. The actuator may operate using electrics, hydraulics or pneumatics and may be linear or non-linear. That is, the actuator may take any form that allows for translation, by the torque assembly, of its actuation into a torque of the processing head attachment bracket around the first rotation axis.

The actuator may be arranged at any point on the boom. Preferably, the actuator may also be arranged on an underside of the boom to prevent damage thereto, similarly as with the hose guide. Advantageously, the actuator may be arranged such that an extension of the actuator acts against a weight of the processing head attachment bracket. For example, the actuator may be arranged on the underside of the boom so that the weight of the processing head acts substantially to push the actuator into itself (i.e., if the actuator is formed of a piston within a cavity, the weight of the processing head would be pushing the against the larger surface area of the piston into the cavity).

The loads carried by the actuator may be very large, such as the weight of an entire felled tree being held by the processing head. As such, the actuator may more efficiently apply torque to the processing head attachment bracket if its extension is acting against the weight, as opposed to allowing the weight to act to pull the actuator into its extending position. Thus, the effectiveness of the actuator is improved and the risk of damage to the actuator is reduced.

A rigid construction of the rigid frames may also contribute to the lifting power of a boom having a processing head attached thereto. It is also preferable that the construction does not excessively include components and that the processing head may articulate with a wide range of motions. Thus, the processing head attachment bracket may further comprise a swivel mount permitting rotation of a processing head relative to the processing head attachment bracket. However, in order to simplify construction whilst maintaining rigidity, the swivel mount may form part of the second rigid frame of the processing head attachment bracket. For example, the swivel mount may be welded (or otherwise attached) to the two or more plates of the second rigid frame, or the entire arrangement may be casted as a single piece.

Similarly, the boom tip attachment bracket and the boom are formed as a single piece or the boom tip attachment bracket is a separate piece from the boom and configured for rigid attachment to the boom. The skilled person would appreciate the associated trade-offs in respect of structural integrity, modularity, and ease of construction, to name a few examples.

The construction of the torque assembly may also take a variety of forms. For example, the torque assembly may comprise an extension portion rigidly extending away from the first rotation axis, such as an elongate portion of the processing head attachment bracket or a rigid bar or beam attached to the processing head attachment bracket. The extension portion may then be rotatably coupled to the actuator, either directly or indirectly through intermediate components. The extension portion is distanced from the first rotation axis so as to allow for the actuator to create a torque around the first rotation axis, via the rotatable coupling to the extension portion.

The torque assembly may be more or less complex than this example, depending on the particular working machine, processing head, and/or anticipated operating forces. For example, the torque assembly may comprise a first boom linkage, having a first end and a second end, and a second boom linkage, having a first end and a second end. The boom linkages may comprise ‘dog bones’, ‘H-links’, ‘bucket links’ or the like, and in some embodiments may form part of a same component (e.g. in the case of an ‘H-link’).

The first end of the first boom linkage may be rotatably coupled to the first rigid frame along a second rotation axis perpendicular to the first rotation axis, the first end of the second boom linkage may be rotatably coupled to the processing head attachment bracket, and the second end of the first boom linkage and the second end of the second boom linkage may then be rotatably coupled to the actuator. In this way, an increased torque around the first rotation axis may be achieved through the added leverage offered by the arrange of boom linkages.

In this example, the internal hose passage may also pass through the second rotation axis. That is, when viewed down a length of the rotation axis, the area defined by the internal hose passage in the first rigid frame overlaps with the second rotation axis, thus preventing interference between the rotatable couplings between the first rigid frame and the boom linkages with the flexible hoses.

The ends of the boom's linkages may be rotatably coupled directly or indirectly to the first and second rigid frames or the actuator. The second end of the first boom linkage and the second end of the second boom linkage may be rotatably coupled to the actuator along a same rotation axis or a different rotation axis. Moreover, the second end of the first boom linkage and the second end of the second boom linkage may be rotatably coupled to a linkage bracket (i.e., some intermediate coupling component, which may then in turn be rotatably coupled to the actuator.

The second rotation axis may have rotatable couplings arranged there along in such a way that a portion or all of the first spacing distance is maintained for the internal hose passage. The internal hose passage may be accommodated for at the second rotation axis in a variety of ways. For example, the first rigid frame may further comprise a third pair of coupling points, arranged at the second rotation axis, and opposed across the first spacing distance, for rotatably coupling the rigid frame to the first end of the first boom linkage along the second rotation axis.

In such an arrangement, the first boom linkage may comprise a pair of first rigid connectors (i.e. individual dog bones or separate portions of an H-link, etc.), each having a first end and a second end, and the first end of the each of the pair of first rigid connectors may be rotatably coupled to a respective coupling point of the third pair of coupling points, either side of the first rigid frame so as to allow for the internal hose passage to pass therethrough. The second end of each of the pair of first rigid connectors may then be rotatably coupled to the actuator in a variety of ways, as discussed above, for example.

The first rigid frame may comprises a pair of outer plates and a corresponding pair of inner plates, each inner plate defining a cavity between said inner plate and its corresponding outer plate, so that the internal hose passage is defined by the gap or space between the inner plates. Each cavity may be arranged at least at the second rotation axis, or extending across a portion of the first rigid frame that coincides with the second rotation axis.

According to this example, each of the pair of first rigid connectors may then be arranged within a respective cavity, each cavity being advantageously configured for motion of the rigid connector during rotation of the second end of the rigid connector about the second rotation axis. Thus, the boom linkages (or the rigid connectors that comprise the boom linkages) may be arranged partially internally between the outer plates of the first rigid frame, whilst being rotatably coupled thereto without risk of interference or obstruction with the flexible hoses, which are safely channeled between the inner plates, thus protecting the flexible hoses from potential entrapment and/or damage from the moving parts of the boom linkages.

As with the first and second pairs of coupling points, the third pair of coupling points may be implemented in any manner that allows for a relative rotation between the rigid connectors of the boom linkages and the first rigid frame, at least for the extent of the range of motion expected during operation. In some examples, each of the third pair of coupling points may comprise a pair of apertures respectively arranged in the outer plate and the inner plate along the second rotation axis. This may form a through-hole or bore that extends from the outer plate, across the cavity, and then through the inner plate. The first end of each rigid connector may then comprise an aperture for receiving a fixing pin so as to preserve the through-hole when placed in alignment along the second rotation axis.

When coupling the rigid connectors to the first rigid frame, according to these examples, the first end of each rigid connector may be rotatably coupled to the first rigid frame by a respective fixing pin extending through the aperture in the outer plate, the aperture in the first end of the rigid connector, and the aperture in the inner plate (i.e. extending through the through-hole so as to rotatably fix the rigid connector in the cavity).

These example arrangements may allow for a further reduction of damage to boom linkages and/or the flexible hoses themselves.

The aforementioned system may be comprised as part of any forestry machine, such as a harvester, a log loader, a feller buncher, or another forestry machine having a processing head attachment rigidly attached to a boom. Such processing heads may be rigid felling heads (with or without rotational capabilities), a rigid processor head, a rigid harvesting head, or a log grapple, for example.

Such forestry machines are often integral to a work process and, thus, damage to them (i.e. damage to their components) can cause them to be out of service whilst the damage is repaired. This can have significant impacts on the time taken to complete the work process. Thus, the present disclosure allows for less downtime of the working machines and an overall reduction in the time taking for the working machines to complete a work process.

### BRIEF DESCRIPTION OF THE DRAWINGS

One or more embodiments will be described, by way of example only, and with reference to the following figures, in which:

FIG. 1 shows an isometric view of a portion of a boom according to an embodiment;

FIG. 2a shows an isometric view of a boom having a processing head attached thereto, according to an embodiment, the processing head being in a lowered position;

FIG. 2b shows a side view of a cross-section across line A-A from FIG. 2a;

FIG. 3a shows an isometric view of a boom having a processing head attached thereto, according to an embodiment, the processing head being in an intermediate position;

FIG. 3b shows a side view of a cross-section across line A-A from FIG. 3a;

FIG. 4a shows an isometric view of a boom having a processing head attached thereto, according to an embodiment, the processing head being in a raised position;

FIG. 4b shows a side view of a cross-section across line A-A from FIG. 4a;

FIG. 5a shows an underside of a boom tip attachment bracket, according to an embodiment;

FIG. 5b shows a side view of a boom tip attachment bracket, according to an embodiment; and

FIG. 5c shows an exploded isometric view of a boom tip attachment bracket, according to an embodiment.

Whilst the invention is susceptible to various modifications and alternative forms, specific embodiments are shown by way of example in the drawings as herein described in detail. It should be understood, however, that the detailed description herein and the drawings attached hereto are not intended to limit the invention to the particular form disclosed. Rather, the intention is to cover all modifications, equivalents, and alternatives falling within the scope of the appended claims.

Any reference to prior art documents or comparative examples in this specification is not to be considered as an admission that such prior art is widely known or forms part of the common general knowledge in the field.

As used in this specification, the words “comprise”, “comprising”, and similar words are not to be interpreted in the exclusive or exhaustive sense. In other words, they are intended to mean “including, but not limited to”.

### DETAILED DESCRIPTION

The present invention is described in the following by way of a number of illustrative examples. It will be appreciated that these examples are provided for illustration and explanation only and are not intended to be limiting on the scope of the present invention. Instead, the scope of the present invention is to be defined by the appended claims. Furthermore, although the examples may be presented in the form of individual embodiments, it will be recognised that the invention also covers combinations of the embodiments described herein.

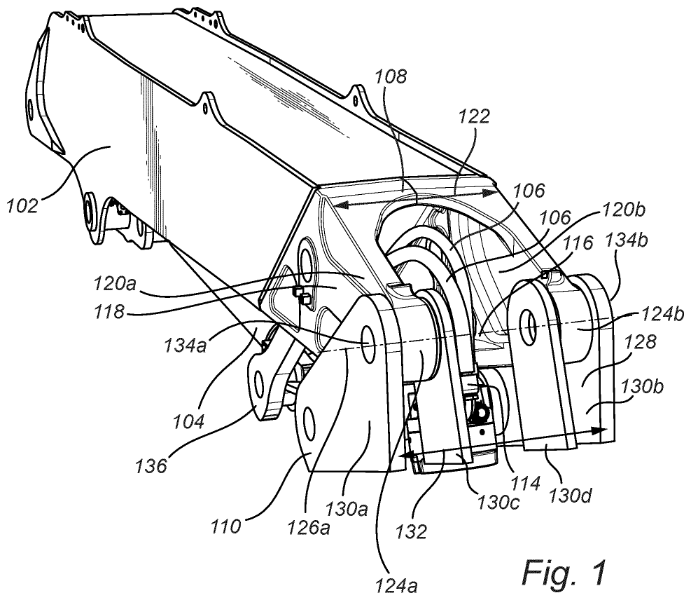

FIG. 1 shows an isometric view of a portion of a boom 102, according to an embodiment. The illustrated system 100 comprises a portion of a boom 102 (e.g. an end of the boom 102) having an actuator 104 attached thereto. In some examples, the actuator 104 may be a piston with a cylinder, such as a hydraulic, pneumatic, or electric piston. The boom 102 is also attached to a boom tip attachment bracket, generally referred to by the arrow 108 (also referred to herein as ‘bracket 108’ for conciseness). The boom 102 may be welded, bolted, clamped, or otherwise permanently or non-permanently attached to the bracket 108, either at the end of the boom 102 (i.e. at its tip) or at some intermediate point along the boom 102.

The boom tip attachment bracket 108 is rotatably coupled to a processing head attachment bracket 110 (also referred to herein as ‘bracket 110’ for conciseness) along a first rotation axis 126a, via a pair of coupling points 124a and 124b on the bracket 108 and a pair of coupling points 134a and 134b (not visible) on the bracket 110. The bracket 108 is formed of a first rigid frame 118 and comprises a pair of plates 120a and 120b that are spaced apart by a first spacing distance 122. The bracket 110 is formed of a second rigid frame 128 and similarly comprises a pair of plates 130a and 130b that are spaced apart by a second spacing distance 132. The plates 120a and 120b may be parallel or arranged at a relative incline to each other, or in any other way that is suitable for creating a spacing distance 122. The same applies to the plates 130a and 130b for creating the second spacing distance 132.

The first spacing distance 122 and the second spacing distance 132 may be the same distance or different distances. It will be appreciated from FIG. 1 that these distances 122 and 132 are influenced partly by the constitution of the coupling points 124a and 124b, and 134a, and 134b. That is, in the illustrated example, the pair of plates 120a and 120b of the first rigid frame 118 extend from an attachment side where the bracket 108 is attached to the boom 102 to an end, proximate the tip of the boom 102, and the pair of first coupling points 124a and 124b are formed as apertures (not visible) at this end. As shown in FIG. 1, the pair of plates 130a and 130b of the second rigid frame 128 have complementary apertures that constitute the pair of second coupling points 134a and 134b.

In the illustrated example, the second rigid frame 128 comprises a further pair of plates 130c and 130c, having further apertures arranged along the first rotation axis 126a. Thus, the first rigid frame 118 and the second rigid frame can be coupled by the addition of a pin (not shown) through the apertures at each of the pairs of coupling points 124a, 124b, 134a, 134b (i.e. a first pin that couples coupling points 124a and 134a, and a second pin that couples coupling points 124b and 134b). The first pin may extend further along the axis 126a into the inner plate 130c of the second rigid frame 128, and the second pin may likewise extend into the inner plate 130d of the second rigid frame 128.

In some examples, the opposite arrangement may be used. That is, instead of the pair of first coupling points 124a, 124b being arranged between the pair of second coupling points 134a, 134b, the pair of second coupling points 134a, 134b may be arranged between the pair of first coupling points 124a, 124b (e.g. receiving a pin that passes through apertures in the same manner as described above).

The configuration of apertures receiving pins therethrough may be referred to as a ‘clevis’. Thus, the arrangement of two such configurations spaced along the first rotation axis 126a may be referred to as a ‘dual clevis’.

The coupling point 124a is opposed across the first spacing distance 122 from its paired coupling point 124b, and the coupling point 134a is opposed across the second spacing distance 132 from its paired coupling point 134b. The coupling points 124a, 124b, 134a, 134b may be spaced apart by the respective spacing distance, a greater distance, or a lesser distance, and may be arranged in any way along the first rotation axis 126a that allows for a space between the respective pairs of coupling points 124a and 134a, and 124b and 134b.

The boom 102 may extend from a working machine such as a forestry machine and may be required to communicate data, electronics, hydraulic fluid, and/or the like from a body of the working machine to processing head. One or more of these may be communicated via one or more flexible lines 106, which may also be referred to as flexible hoses 106 or simply hoses 106. In the illustrated example, two hoses 106 are shown. However, there may be more or fewer hoses 106, or these hoses 106 may be contained within a common hose 106. For example, power cables and hydraulic fluid may be fed through a same hose in order to further reduce space required within the rigid frames 118, 128, protect the power cable, or cool the power cable (which may get hot during operation) with the flow of hydraulic fluid. The same applies to any combination of pneumatics, data, or other lines/hoses 106 required for transmission to the processing head 112.

As can be appreciated from FIG. 1, the construction of the first rigid frame 118 and the second rigid frame 128 to be formed of at least two plates 120a, 120b, 130a, 130b spaced apart by respective first and second spacing distances 122, 132 leads to the formation of a frame having an open interior, which can also be thought of as an ‘open box shape’. Thus, the hoses 106 may freely move around this interior during an articulation of the processing head attachment bracket 110 (i.e. during articulation of a processing head attached thereto). This internal space for free movement of the lines 106 is referred to as an internal hose passage 116.

The use of the term ‘plate’ is not intended to convey shape or dimension, and the plates 120, 130 may be part of a mesh structure, may be flat or curved, formed of one or more bars or wires, and/or may be welded together from component parts or casted monolithically, providing that the plates 120, 130 allow for an internal line/hose passage 116 therethrough.

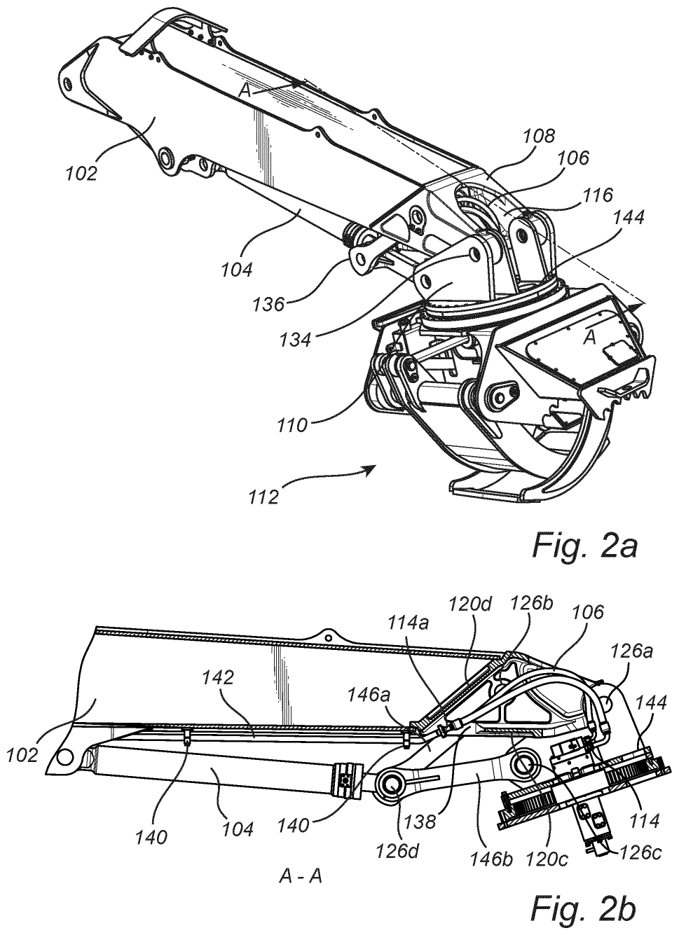

The advantages of providing this internal hose passage 116 are explained in more detail with relation to FIGS. 2a-b, 3a-b, and 4a-b.

FIGS. 2a, 3a, and 4a show a series of isometric views of a boom 102 having a processing head 112 rigidly attached thereto, yet articulatable by actuation of the actuator 104, so as to, via the torque assembly 136, rotate the processing head 112 about the first rotation axis 126a.

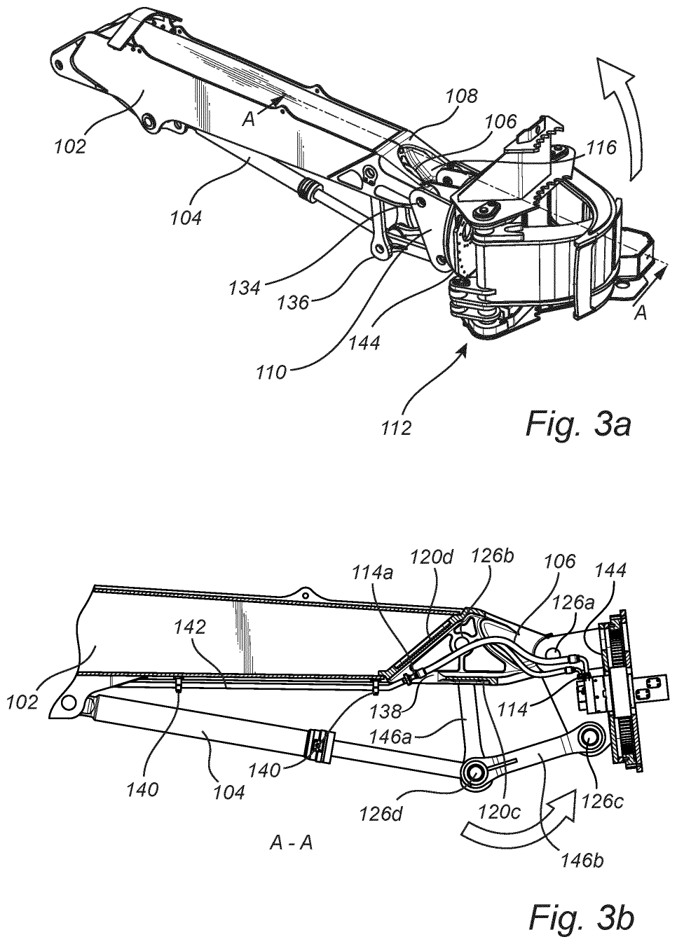

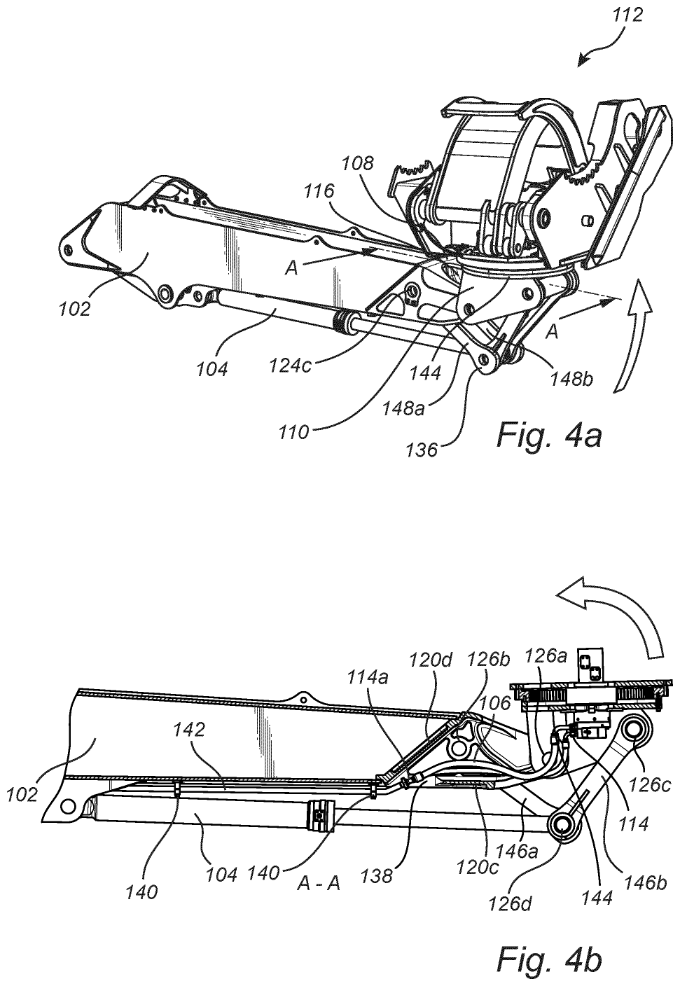

This rotation is shown as a progression from a lowered position in FIGS. 2a-b (actuator 104 retracted entirely), through an intermediate position in FIGS. 3a-b, to a raised position in FIGS. 4a-b (actuator 104 extended entirely).

FIGS. 2b, 3b, and 4b show side views of cross-sections through line A-A in their correspondingly numbered figure.

As shown in FIG. 2b, the hoses 106 are guided along the boom 102 by a guide 140 (also referred to herein as a ‘hose guide 140’ or ‘line guide 140’), which in this illustrated example is a series of clamps on the underside of the boom 102, although the hose guide 140 may instead take the form of a series of weld points, a netting, ties, or other components that are suitable for guiding hoses 106 along the boom 102. Furthermore, according to this example, the hoses 106 extend from an end of the hose guide 140 that further comprises a protective conduit 142, such as a metal or plastic piping. The hose guide 140 terminates proximate to an opening 138 in the first rigid frame 118, which is provided by the configuration of a support plate 120c that extends between the two side-opposing plates 120a, 120b of the first rigid frame 118. The flexible hoses 106 are shown as being coupled via a secondary hose coupling point 114a, such that the flexible hoses 106 extend from the secondary hose coupling point 114a to the hose coupling point 114 on the processing head attachment bracket 114.

In the illustrated example, the hose guide 140 is arranged on an underside of the boom 102, however other examples may include a hose guide 140 on the top of the boom 102, or a side of the boom 102. In further examples, the hose guide 140 may be internally routed through a length of the boom 102, thus providing further protection to the hoses 106 as they are routed from the body of the working machine. In such cases, the protective conduit 142 may not be necessary. It is also seen that the back plate 120d of the first rigid frame 118 may provide the opening 138 to the internal hose passage 116 rather than the support plate 120c. In some other examples, the hose guide 140 and/or protective conduit 142 may be integrally formed with the boom 102 such as in a channel or recess formed in a side of the boom 102.

In some examples, the hose guide 140 and/or the protective conduit 142 may terminate some distance from the opening 138, depending on the amount of protection desired for the hoses 106.

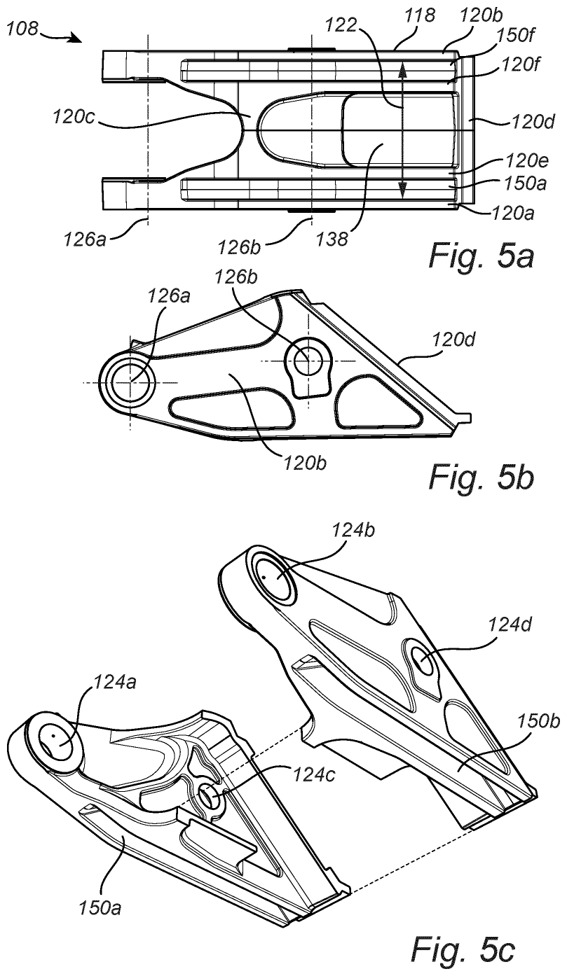

As will be appreciated from 2b, 3b, and 4b in particular, the internal hose passage 116 passes through the first rotation axis 126a. In some examples, including that illustrated, the internal hose passage 116 may also pass through a second rotation axis 126b. A technique for providing this latter feature is discussed below in relation to FIGS. 5a-c.

The provision of the dual clevis arrangement, as described above, allows the internal hoses 106 to pass unobstructed through the first rigid frame 118 and the second rigid frame 128 to the hose attachment point 114. Therefore, the hoses 106 may be configured to have a minimum length required for the full range of motion, thus saving materials and not requiring less internal space to accommodate the hoses 106, i.e. the internal hose passage 116 can be made smaller as a consequence of the coupling points 124a, 124b, 134a, 134b being spaced apart (e.g. in a ‘dual clevis’ configuration). The support plate 120c extends between the ends of the plates 120a and 120b, so as to further reduce the obstruction of the hoses 106.

The first rigid frame 118 of the boom tip attachment bracket 108 is discussed in more detail below in relation to FIGS. 5a-c. The second rigid frame 128 may further comprise a bridging plate or some other structure that joins the plates 130a and 130b either directly or indirectly so as to form a rigid structure. In some examples, such as that illustrated in FIG. 2b, the second rigid frame 128 of the bracket 110 further comprises a swivel mount 144 permitting rotation of the processing head 112 relative to the processing head attachment bracket 110, and said swivel mount 144 forms part of the second rigid frame 110, e.g. rigidly joining the plates 130a and 130b. This construction allows for further degrees of freedom of motion for the processing head 112 without unnecessarily increasing the number of components. The swivel mount 144 (or a portion thereof) may be integrally formed with the plates 130a, 130b (such as by casting), may be welded thereto, bolted thereto, or attached by some other means.

The torque assembly 136 is now discussed in association with the illustrated examples. The torque assembly 136 shown in the figures comprises a first boom linkage 146a and a second boom linkage 146b. Each of these boom linkages 146a, 146b may be formed of rigid connectors 148a, 148b such as dog bones, an H-link, or the like, or may take some other form. An arrangement that is symmetrical about a central axis of the 102 may better resist damage from rotational forces around the axis of the boom 102.

The first boom linkage 146a extends from a first end and a second end, connecting the actuator 114 to the first rigid frame 118 at a second rotation axis 126b. The second boom linkage 126b also extends from a first end to a second end, connecting the actuator 114 to the second rigid frame 128 at a third rotation axis 126c. Each of the couplings between the torque assembly 136 and the first and second rigid frames 118, 128 are rotatable couplings to allow for rotation at each coupling. The couplings at the actuator 114 are arranged along a fourth rotation axis 126d. Each of the first to fourth rotation axes 126a-d are parallel in this example.

As is best shown by FIG. 4a, the first boom linkage 146a comprises a pair of first rigid connectors 148a, 148b, each having a first end and a second end (corresponding to the first and second ends of the first boom linkage 146a that they constitute). Each rigid connector 148a, 148b is rotatably coupled to a respective coupling point of a third pair of coupling points 124c, 124d (124d not visible in the figures) in the first rigid frame 118.

As shown in FIGS. 5a-c, the rigid connectors 148a, 148b may be connected to the first rigid frame 118 of the bracket 108 in such a way that they are housed at least partially housed within the first rigid frame 118.

The first rigid frame 118 may comprise the pair of outer plates 120a, 120b and also a pair of inner plates 120e, 120f, each inner plate 120e, 120f being spaced from a respective outer plate 120a, 120b so as to form a pair of cavities 150a, 150b therein between. As shown in FIGS. 5a and 5c in particular, the cavities 150a, 150b may be arranged at least at the second rotation axis 126b (i.e. the coupling point for the first boom linkage 146a) so as to allow for a motion of the rigid connectors 148a, 148b during articulation of the processing head 112.

It can be seen from these figures how the rigid connectors 148a, 148b may advantageously be contained at least partially within the enclosed volume of the first rigid frame 118 of the bracket 108. The coupling of the rigid connectors 148a, 148b to respective coupling points of the third pair of coupling points 124c, 124d may then be carried out by any means, for example via the addition of a pin through apertures along the second rotation axis 126b.

This arrangement of the rigid connectors 148a, 148b thus allows for a spacing between the couplings at the third coupling points 124c, 124d. Furthermore, the inner plates 120e, 120f may then form a boundary for the internal hose passage 116, thus protecting the hoses 106 from the moving parts around the second rotation axis 126b. That is, the internal hose passage 116, according to this example, may pass through the second rotation axis 126b as well as the first rotation axis 126a.

Therefore, the hoses 106 may be further protected within the brackets 108, 110 and a minimum length of the hoses 106 may be used. As can be seen from FIGS. 2b, 3b, and 4b, the articulation of the processing head 112 may cause the hoses to flex and pass through the first rotation axis 126a and the second rotation axis 126b. Thus, by providing couplings that are spaced apart, the internal hose passage 116 may pass through one or both of these rotation axes 126a, 126b such that the hoses 106 are not obstructed across the entire range of motion when rotating the processing head 112 about the first rotation axis 126a.

In the illustrated examples, the actuator 114 and the associated torque assembly 126 are arranged on an underside of the boom 102. More particularly, the actuator 114 is arranged such that an extension of the actuator 114 acts against a weight of the processing head attachment bracket 110 (and, by extension, any processing head 112 attached thereto). This arrangement provides a number of advantages. For example, the actuator 114 and the torque assembly 136 are protected from debris or other damage that could come from above, by the main structure of the boom 102. Furthermore, the actuator 114 is prevented from damage by excessive torsional load on the bracket 110, as the actuator 114 can more readily resist compression (pushing forces) than extension (pulling forces).

The illustrated torque assembly 136 advantageously provides an improved lifting capacity. The torque assembly 136 may take other forms that are more or less complex than that illustrated. For example, the torque assembly may comprise an extension portion, such as an extension from the second rigid frame 128 that is directly or indirectly coupled to the actuator 114 (e.g. via a linkage bracket which may in turn be rotatably coupled to the actuator 114). Such an arrangement may advantageously remove the need for moving parts facilitation the operation of the torque assembly 136 in the proximity of the hoses 106.

As will be appreciated, the distance between the rotation axes 126a and 126b will affect the torque applicable by the torque assembly 136. The same applies to the length, shape, and form of the boom linkages 146a, 146b, which may be adapted according to need.

The boom tip attachment bracket 108 shown in FIG. 5c is formed as a single piece, for example by casting. However, the bracket 108 (being formed primarily as the rigid frame 118) may instead be welded together from separate parts, or bolted together, according to the particular implementation. The bracket 108 may then be attached to the boom by welding, bolting, or some other technique. In some examples, the boom tip attachment bracket 108 may be integrally formed as part of the boom 102 and/or the processing head attachment bracket may be integrally formed as part of the processing head 112.

Although specific example embodiments have been described with respect to the figures, it is considered that this discussion is not limiting upon the scope of the invention, which is instead defined by the scope of the following claims.

1. A system comprising:
a boom tip attachment bracket on a boom of a working machine, the boom having an actuator attached thereto and one or more flexible lines;
a processing head attachment bracket for rigidly attaching a processing head to the boom of the working machine, the processing head attachment bracket having a line connection point for connecting the one or more flexible lines; and
an internal line passage for passage of the one or more flexible lines from the boom to the line connection point;
wherein the boom tip attachment bracket comprises:
a first rigid frame having at least two plates spaced from each other by a first spacing distance so as to comprise at least a portion of the internal line passage;
a pair of first coupling points opposed across the first spacing distance, for rotatably coupling the rigid frame to the processing head along a first rotation axis;
wherein the processing head attachment bracket comprises:
a second rigid frame having at least two plates spaced from each other by a second spacing distance so as to comprise at least a portion of the internal line passage; and
a pair of second coupling points, opposed across the second spacing distance, and rotatably coupled with the pair of first coupling points along the first rotation axis;
wherein the processing head attachment bracket is coupled to the actuator by a torque assembly for translating actuation of the actuator into a rotation of the processing head attachment bracket about the first rotation axis; and
wherein the internal line passage passes through at least the first rotation axis.

2. The system according to claim 1, wherein:
each of the pair of first coupling points comprises an aperture configured to receive a clevis pin;
each of the pair of second coupling points comprises a clevis configured to receive a clevis pin; and
the pair of first coupling points and the pair of second coupling points are rotatably coupled by respective clevis pins extending through the clevis and the aperture.

3. The system according to claim 1, wherein:
the first rigid frame comprises a support plate extending between an edge of each of the at least two plates of the first rigid frame; and
the support plate is configured to provide an opening to the internal line passage.

4. The system according to claim 1, wherein:
the boom comprises a guide configured to guide the one or more flexible lines along the boom to the internal line passage.

5. The system according to claim 4, wherein:
the guide comprises a protective conduit fixed to the boom.

6. The system according to claim 5, wherein:
the guide is arranged on an underside of the boom.

7. The system according to claim 1, wherein:
the actuator is arranged such that an extension of the actuator acts against a weight of the processing head attachment bracket.

8. The system according claim 1, wherein:
the processing head attachment bracket further comprises a swivel mount permitting rotation of a processing head relative to the processing head attachment bracket; and
the swivel mount forms part of the second rigid frame.

9. The system according to claim 1, wherein:
the boom tip attachment bracket and the boom are formed as a single piece or the boom tip attachment bracket is a separate piece from the boom and configured for rigid attachment to the boom.

10. The system according claim 1, wherein:
the torque assembly comprises an extension portion rigidly extending away from the first rotation axis; and
the extension portion is rotatably coupled to the actuator.

11. The system according to claim 1, wherein:
the torque assembly comprises:
a first boom linkage, having a first end and a second end; and
a second boom linkage, having a first end and a second end;
wherein:
the first end of the first boom linkage is rotatably coupled to the first rigid frame along a second rotation axis perpendicular to the first rotation axis;
the first end of the second boom linkage is rotatably coupled to the processing head attachment bracket;
the second end of the first boom linkage and the second end of the second boom linkage are rotatably coupled to the actuator; and
the internal hose passage passes through the second rotation axis.

12. The system according to claim 11, wherein:
the second end of the first boom linkage and the second end of the second boom linkage are rotatably coupled to the actuator along a same rotation axis.

13. The system according to claim 11, wherein:
the second end of the first boom linkage and the second end of the second boom linkage are rotatably coupled to a linkage bracket; and
the linkage bracket is rotatably coupled to the actuator.

14. The system according to claim 11, wherein:
the first rigid frame further comprises a third pair of coupling points, arranged at the second rotation axis, and opposed across the first spacing distance, for rotatably coupling the rigid frame to the first end of the first boom linkage along the second rotation axis; and
the first boom linkage comprises a pair of first rigid connectors, each having a first end and a second end;
the first end of the each of the pair of first rigid connectors is rotatably coupled to a respective coupling point of the third pair of coupling points;
the second end of each of the pair of first rigid connectors is rotatably coupled to the actuator.

15. The system according to claim 14, wherein:
the first rigid frame comprises a pair of outer plates and a corresponding pair of inner plates, each inner plate defining a cavity between said inner plate and its corresponding outer plate, the cavity being arranged at least at the second rotation axis;
each of the pair of first rigid connectors is arranged within a respective cavity;
each cavity is configured for motion of the rigid connector during rotation of the second end of the rigid connector about the second rotation axis; and
the internal line passage is comprised between the pair of inner plates.

16. The system according to claim 15, wherein:
each of the third pair of coupling points comprises a pair of apertures respectively arranged in the outer plate and the inner plate along the second rotation axis;
the first end of each rigid connector comprises an aperture for receiving a fixing pin; and
the first end of each rigid connector is rotatably coupled to the first rigid frame by a respective fixing pin extending through the aperture in the outer plate, the aperture in the first end of the rigid connector, and the aperture in the inner plate.

17. A forestry machine comprising the system of claim 1.
